(19) United States
(12) Patent Application Publication
(10) Pub. No.: US 2016/0380884 A1
(43) Pub. Date: Dec. 29, 2016

(54) Flow-Based Distribution in Hybrid Access Networks

(71) Applicant: Futurewei Technologies, Inc., Plano, TX (US)

(72) Inventors: Behcet Sarikaya, Wylie, TX (US); Mingui Zhang, Shenzhen (CN)

(21) Appl. No.: 15/188,749

(22) Filed: Jun. 21, 2016

Related U.S. Application Data
(60) Provisional application No. 62/185,007, filed on Jun. 26, 2015.
(60) Provisional application No. 62/186,597, filed on Jun. 30, 2015.

(51) Int. Cl. H04L 12/721; H04L 12/66; H04L 12/931

(52) U.S. Cl. CPC H04L 45/38; H04L 49/60; H04L 12/66

(57) ABSTRACT

A first node implemented in a hybrid access network is provided. The first node comprises a receiver configured to receive instructions to implement flow-based distribution, a processor coupled to the receiver and configured to generate a first control message instructing the flow-based distribution, and a transmitter coupled to the processor and configured to transmit the first control message to a second node in the hybrid access network.

### CROSS-REFERENCE TO RELATED APPLICATIONS

This application claims priority to U.S. provisional patent application No. 62/185,007 filed Jun. 26, 2015 by Behcet Sarikaya and Mingui Zhang and titled “Supporting User Flow Mobility in GRE Notifications for Hybrid Access” and to U.S. provisional patent application No. 62/186,597 filed Jun. 30, 2015 by Mingui Zhang, et al., and titled “Demultiplexing Bonded GRE Tunnels,” which are incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A packet is a formatted unit of data communicated in a computer network. In packet-based packet distribution, which is also referred to as packet-based packet processing, stateless processing, or packet-based distribution, each packet is assessed individually for treatment. In flow-based packet distribution, which is also referred to as flow-based packet processing or flow-based distribution, all packets in a packet stream are treated in the same way. The treatment depends on characteristics established for the first packet in the packet stream. The packet stream may also be referred to as a packet flow, a user flow, or simply a flow.

At least two planes, a control plane and a data plane, implement packet-based distribution. The control plane makes forwarding and routing decisions. Functions of the control plane include network configuration, network management, and routing table exchanging. A router either originates control plane messages or receives control plane messages, which may be referred to simply as control messages. The router updates routing tables based on control plane messages.

The data plane, which is also referred to as the forwarding plane, the user plane, the carrier plane, or the bearer plane, defines a part of a network that routes a packet. Functions of the data plane include forwarding tables, routing tables, queues, and tagging. For instance, the data plane comprises a table that a router uses to determine a path from a transmitting node to a receiving node. In other words, the data plane implements commands of the control plane. Thus, data plane messages travel through the router.

### SUMMARY

Current approaches implement packet-based distribution for a network to accommodate different links. However, it is desirable to also implement flow-based distribution for the network to accommodate the different links because operators may require such flow-based distribution. According to various embodiments of the present disclosure, embodiments for flow-based distribution in hybrid access networks are provided. A hybrid access gateway (HAG) may assign to a hybrid customer premises equipment (HCPE) an operator-required distribution policy, a flow table, and flow mobility. Similarly, the HCPE may assign to the HAG the operator-required distribution policy, the flow table, and the flow mobility. Control messages identify the distribution policy, for instance the flow-based distribution policy, and attributes of the control messages identify the flow table. Subsequent control messages and their attributes implement updates on a flow table and therefore may also induce flow mobility. The control messages may be GRE control messages. The flow-based distribution complements packets-based distribution, which data plane messages, control messages, and their attributes implement.

A first node implemented in a hybrid access network is provided. The first node comprises a receiver configured to receive instructions to implement flow-based distribution, a processor coupled to the receiver and configured to generate a first control message instructing the flow-based distribution, and a transmitter coupled to the processor and configured to transmit the first control message to a second node in the hybrid access network.

In some examples, the first node is a hybrid customer premises equipment (HCPE) and the second node is a hybrid access gateway (HAG) or wherein the first node is a hybrid access gateway (HAG) and the second node is a hybrid customer premises equipment (HCPE). In some examples, the first control message comprises a field including an identifier (ID) of a flow to implement the flow-based distribution. In some examples, the first node further comprises a first interface configured to couple to a first link of a first protocol, standard, or technology, and a second interface configured to couple to a second link of a second protocol, standard, or technology. In some examples, the first node further comprises the first link is a wired link and the second link is a wireless link. In some examples, the first link is a digital subscriber line (DSL) link and the second link is a Long-Term Evolution (LTE) link. In some examples, the first node is configured to transfer packets via the first link and transfer flows via the second link or transfer packets via the second link and transfer flows via the first link. In some examples, the first node is configured to transfer packets via the first link and transfer flows via a second link GRE tunnel in the second link or transfer packets via the second link and transfer flows via a first link GRE tunnel in the first link. In some examples, the first node is configured to switch flows between the first link and the second link. In some examples, the processor is further configured to generate a second control message instructing switching a flow from the first link to the second link, and wherein the transmitter is further configured to transmit the second control message to the second node. In some examples, the first control message and the second control message are Generic Routing Encapsulation (GRE) notify messages.

A method implemented in a first node of a hybrid access network is provided. The method comprises receiving instructions to implement flow-based distribution, generating a first control message instructing the flow-based distribution and identifying a first flow table, and transmitting the first control message to a second node in the hybrid access network.

In some examples, the method further comprises coupling to a first tunnel of a first protocol, standard, or technology, and coupling to a second tunnel of a second protocol, standard, or technology. In some examples, the method further comprises switching flows between the first tunnel and the second tunnel based on network congestion or other network conditions. In some examples, the method further comprises generating a second control message instructing switching a flow from the first tunnel to the second tunnel and identifying a second flow table, and transmitting the second control message to the second node.

A first node implemented in a hybrid access network is provided. The first node comprises a receiver configured to receive packets. The first node further comprises a processor coupled to the receiver and configured to encapsulate the packets to create encapsulated packets, and generate a first control message instructing flow-based distribution and comprising a first flow table, wherein the first flow table identifies a flow and comprises instructions for processing packets belonging to the flow. The first node further comprises a transmitter coupled to the processor and configured to transmit the first control message to a second node in the hybrid access network, and transmit the encapsulated packets to the second node for processing based on the first control message.

In some examples, the first node is a hybrid customer premises equipment (HCPE), wherein the receiver is further configured to further receive the packets from one or more user equipments (UEs), wherein the packets are data packets, and wherein the processor is further configured to further encapsulate the packets using Generic Routing Encapsulation (GRE). In some examples, the first node is a hybrid access gateway (HAG), wherein the receiver is further configured to further receive the packets from a service, wherein the packets are Internet Protocol (IP) packets, and wherein the processor is further configured to further encapsulate the packets using Generic Routing Encapsulation (GRE). In some examples, the first control message comprises a message type (MsgType) field indicating a Generic Routing Encapsulation (GRE) notify message, and an attribute type field indicating a filter list package, wherein the filter list package comprises the first flow table and a 5-tuple identifying the flow, and wherein the filter list package identifies a single node associated with the flow or identifies a plurality of nodes associated with the flow. In some examples, the first control message is a Generic Routing Encapsulation (GRE) notify message, wherein the receiver is further configured to receive, in response to the first control message, a second control message that is a GRE notify acknowledgment (ack) message, and wherein the first control message and the second control message complete a control message handshake. In some examples, the processor is further configured to generate a second control message instructing switching the flow from a digital subscriber line (DSL) link to a Long-Term Evolution (LTE) link using a second flow table, wherein the second control message comprises a message type (MsgType) field indicating a Generic Routing Encapsulation (GRE) notify message and an attribute type field indicating a filter list package, wherein the filter list package comprises the second flow table and a 5-tuple identifying the flow, and wherein the transmitter is further configured to transmit the second control message to the second node. In some examples, the first node is configured to switch flows between a first link and a second link.

A first node implemented in a hybrid access network is provided. The first node comprises a processor configured to generate a Generic Routing Encapsulation (GRE) notify message comprising a first header and a filter list package attribute, wherein the first header comprises a first message type field identifying the GRE notify message, a first attribute type field identifying the filter list package attribute, and a tunnel type field identifying a tunnel, and wherein the filter list package attribute comprises a description value field identifying a flow identifier (ID) and a 5-tuple identifying a flow associated with the flow ID. The first node further comprises a transmitter coupled to the processor and configured to transmit, via a tunnel, the GRE notify message to a second node.

In some examples, the first node further comprises a receiver coupled to the processor and configured to receive, via the tunnel, a GRE notify acknowledgment (ack) message in response to the GRE notify message, wherein the GRE notify ack message comprises a second header and a filter list ack attribute, wherein the second header comprises a second message type field identifying the GRE notify ack message and a second attribute type field identifying the filter list ack attribute, wherein the filter list ack attribute comprises an error code identifying an acknowledgment, and wherein the processor is further configured to process the GRE notify ack message.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a hybrid access network according to an embodiment of the disclosure.

FIG. 2 is a schematic diagram of a device according to an embodiment of the disclosure.

FIG. 3 is a message sequence diagram illustrating establishment of a tunnel using flow-based distribution according to an embodiment of the disclosure.

FIG. 4 is a schematic diagram of a header for a control message.

FIG. 5 is a schematic diagram of a filter list package attribute according to an embodiment of the disclosure.

FIG. 6 is a flowchart illustrating a method of instructing flow-based distribution according to an embodiment of the disclosure.

FIG. 7 is a flowchart illustrating a method of a GRE notify message handshake according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following acronyms and initialisms apply:

3G: third generation

4G: fourth generation

5G: fifth generation

ack: acknowledgement

AN: access node

ASIC: application specific integrated circuit

ASCII: American Standard Code for Information Interchange

AVP: attribute-value pair

BW: bandwidth

CIN: client identification name

CPU: central processing unit

DNS: domain name system

DSCP: differentiated services code point

DSL: digital subscriber line

DSP: digital signal processors

eNodeB or eNB: evolved terrestrial UMTS radio access node Bs

EO: electrical-to-optical

EPC: evolved packet core

ETSI: European Telecommunications Standards Institute

FGPA: field-programmable gate array

GRE: Generic Routing Encapsulation

HAG: hybrid access gateway

HCPE: hybrid customer premises equipment

ID: identifier

IP: Internet Protocol

IPTV: IP television

IPv4: IP Version 4

IPv6: IP Version 6

kb/s: kilobits per second

LTE: Long-Term Evolution

MAC: media access control

ms: milliseconds

MTU: maximum transmission unit

nack: negative ack

OE: optical-to-electrical

P2P: point-to-point

PC: personal computer

RAM: random-access memory

RFC: request for comments

RG: residential gateway

ROM: read-only memory

RTT: round-trip time

RX: receiver unit

s: seconds

SN: service node

SRAM: static RAM

TCAM: ternary content-addressable memory

TX: transmitter unit

UE: user equipment

UMTS: Universal Mobile Telecommunications System

VPN: virtual private network.

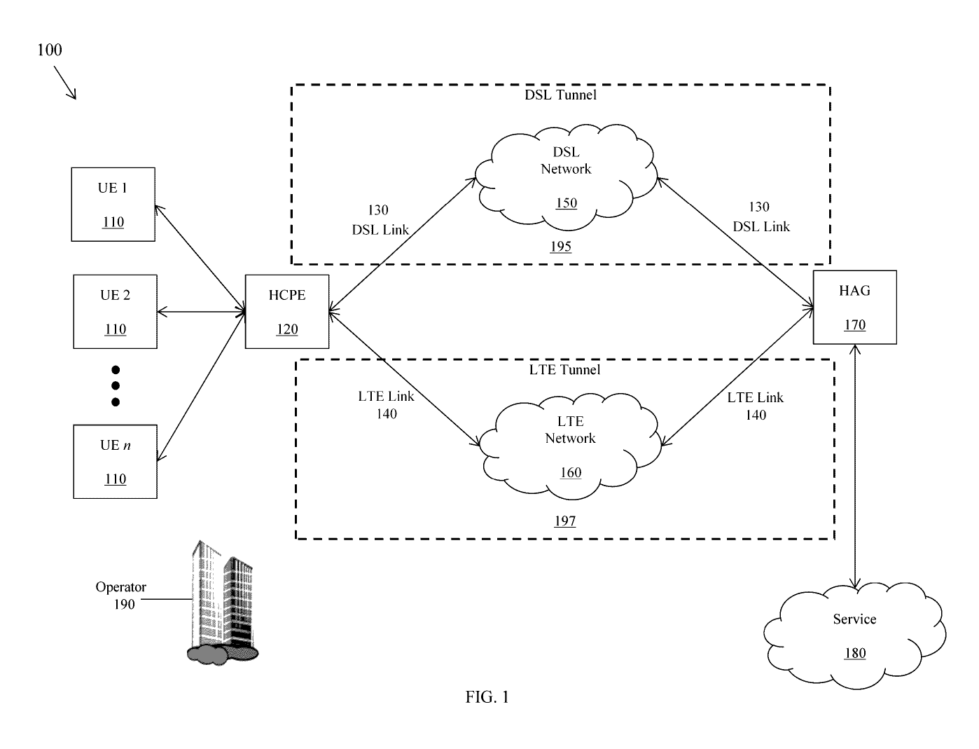

FIG. 1 is a schematic diagram of a hybrid access network 100 according to an embodiment of the disclosure. The network 100 comprises n UEs 110, a HCPE 120, a DSL link 130, a LTE link 140, a DSL network 150, a LTE network 160, a HAG 170, and a service 180. The number n is a positive integer. A first direction from the UEs 110 to the service 180 is an upstream direction, and a second direction from the service 180 to the UEs 110 is a downstream direction.

The hybrid access network 100 according to an embodiment or embodiments provides both packet-based distribution and flow-based distribution. The hybrid access network 100, by providing both packet-based distribution and flow-based distribution, accommodates different network links, including LTE and DSL links in some examples. The HCPE 120 always has two links, while the HAG 170 may be located in the Internet, but is able to receive/send from two links, even though the HAG 170 may not always be directly connected to two links.

The hybrid access network 100 employs a generic routing encapsulation (GRE) tunnel bonding protocol as part of providing the packet-based distribution and the flow-based distribution. GRE tunnel bonding is discussed in “GRE Tunnel Bonding,” by N. Leymann et al., IETF draft-zhang-gre-tunnel-bonding-02.txt, May 6, 2016, which is incorporated by reference.

GRE tunnel bonding can be used to create a GRE tunnel for handling flows in the hybrid access network 100. A GRE tunnel can be created between the HCPE 120 and the HAG 170 as a DSL tunnel, using the DSL network 150. Such a DSL GRE tunnel can be used to transfer flows between the HCPE 120 and the HAG 170 in either direction, for example.

Alternatively, or in addition, a GRE tunnel can be created between the HCPE 120 and the HAG 170 as a LTE tunnel, using the LTE network 160. Such a LTE GRE tunnel can be used to transfer packets between the HCPE 120 and the HAG 170 in either direction, for example. In other examples, flows and packets can be transferred using one or both of the DSL GRE tunnel and the LTE GRE tunnel.

The UEs 110 are mobile phones, PCs, tablets, or other suitable devices belonging to customers. The HCPE 120 is a terminal device located at or near the customer's premises. The HCPE 120 may also be referred to as an RG. The HCPE 120 comprises a UE interface for the UEs 110, a DSL interface for the DSL link 130, and an LTE interface for the LTE link 140. The HCPE 120 therefore provides a coupling between the UEs 110 on the one hand and the DSL link 130 and the LTE link 140 on the other hand. The UE interface may be multiple UE interfaces or may comprise separate UE sub-interfaces for each of the UEs 110.

The DSL link 130 generally comprises above-ground or underground copper wires or is otherwise a land-based or wire link (i.e., is a wire link of some sort, with the wired link including one or more wires, cables, electrical conductors, or optical conductors). The DSL link 130 provides communication between the HCPE 120 and the DSL network 150 and between the DSL network 150 and the HAG 170 using electrical signals. The DSL network 150 comprises ANs, SNs, and other components for providing DSL services. Together, the DSL link 130 and the DSL network 150 may form a DSL tunnel 195.

The LTE link 140 generally comprises an air-based or wireless link (i.e., is a wireless link employing electrical, optical, acoustic, or other wireless transmission schemes). The LTE link 140 provides communication between the HCPE 120 and the LTE network 160 and between the LTE network 160 and the HAG 170 using radio signals. The LTE link 140 may also be referred to as a 4G link. The LTE network 160 comprises eNBs, an EPC, and other components for providing LTE services. Together, the LTE link 140 and the LTE network 160 may form a LTE tunnel 197.

Though the DSL link 130, the LTE link 140, the DSL network 150, and the LTE network 160 are shown, the network 100 may comprise any number of such links and networks and may comprise any number of other links and networks such as 3G and 5G links and networks. The network 100 is a hybrid access network because it employs the DSL link 130, the LTE link 140, the DSL network 150, and the LTE network 160 and because DSL and LTE are different protocols, standards, or technologies.

The HAG 170 is a network device that translates various protocols. The HAG 170 comprises a DSL interface for the DSL link 130, an LTE interface for the LTE link 140, and a service interface for the service 180. If the network 100 comprises additional services such as the service 180, then the service interface may be multiple service interfaces or may comprise separate service sub-interfaces for each of the services. The HAG 170 therefore provides a coupling between the DSL link 130 and the LTE link 140 on the one hand and the service 180 on the other hand. The UEs 110, the HCPE 120, components in the DSL network 150, components in the LTE network, the HAG 170, and components in or associated with the service 180 may be referred to as nodes.

The HCPE 120 and the HAG 170 employ GRE, which is a tunneling protocol that encapsulates network layer protocols inside virtual P2P links over an IP network. A tunneling protocol allows a customer to access or provide a network service that the underlying network does not directly support or provide. Thus, the HCPE 120 receives data packets from the UEs 110, encapsulates the data packets using GRE, and transmits the encapsulated packets to the HAG 170 using either the DSL tunnel 195 or the LTE tunnel 197. The HAG 170 decapsulates the encapsulated packets to obtain IP packets and transmits the IP packets to the service 180. Similarly, the HAG 170 receives IP packets from the service 180, encapsulates the IP packets using GRE, and transmits the encapsulated packets to the HCPE 120 using either the DSL tunnel 195 or the LTE tunnel 197. The HCPE 120 decapsulates the encapsulated packets to obtain data packets and transmits the data packets to the UEs 110.

The service 180 is the Internet, a VPN, or other suitable service. The operator 190 is an entity such as AT&T or Verizon that provides communications services to the customers. The operator 190 controls the network 100, including both the HCPE 120 and the HAG 170. Alternatively, the operator 190 controls one of the HCPE 120 or the HAG 170 and another operator controls the other one of the HCPE 120 or the HAG 170.

The DSL link 130 and the DSL network 150 may not provide sufficient bandwidth, particularly if they are located in urban areas with many customers and corresponding UEs 110. In addition, it may be too expensive to update the components of the DSL link 130 and the DSL network 150 with higher-capacity components because the DSL link 130 is underground. As a result, updating the components DSL link 130 and the DSL network 150 requires extensive demolition and construction of the network 100 and surrounding infrastructure. The addition of the LTE link 140 and the LTE network 160 therefore provides an opportunity for increased bandwidth for the UEs 110 without requiring demolition and construction because the LTE link 140 is aboveground. Some approaches implement packet-based distribution for the network 100 to accommodate the LTE link 140 and the LTE network 160. However, it is desirable to also implement flow-based distribution for the network 100 to accommodate the LTE link 140 and the LTE network 160 because operators may require such flow-based distribution.

Disclosed herein are embodiments for flow-based distribution in hybrid access networks. A HAG may assign to the HCPE an operator-required distribution policy, a flow table, and flow mobility. Similarly, the HCPE may assign to the HAG the operator-required distribution policy, the flow table, and the flow mobility. The distribution policy dictates whether the HCPE and the HAG should implement packet-based distribution or flow-based distribution. The flow table identifies a flow and comprises instructions for processing packets belonging to the flow. Thus, a node comprising the flow table filters packets belonging to the flow and processes those packets according to the instructions in the flow table. Flow mobility allows nodes to switch between two tunnels or among more than two tunnels and their respective components based on network congestion, other network conditions, or other suitable criteria. Control messages identify the distribution policy, for instance the flow-based distribution policy, and attributes of the control messages identify the flow table. Subsequent control messages and their attributes implement flow mobility. The control messages may be GRE control messages. The flow-based distribution complements packets-based distribution, which data plane messages, control messages, and their attributes implement.

A flow is a group of packets matching a traffic selector. A network implementing per-flow traffic distribution of IP traffic forwards all packets with a common 5-tuple over the same path. The 5-tuple comprises a source IP address field, a source port field, a destination IP address field, a destination port field, and protocol field. Flow-based distribution is discussed, for example, in the Broadband Forum's technical report “TR-348 Hybrid Access Broadband Network Architecture”, published by The Broadband Forum, Issue 1, June 2016

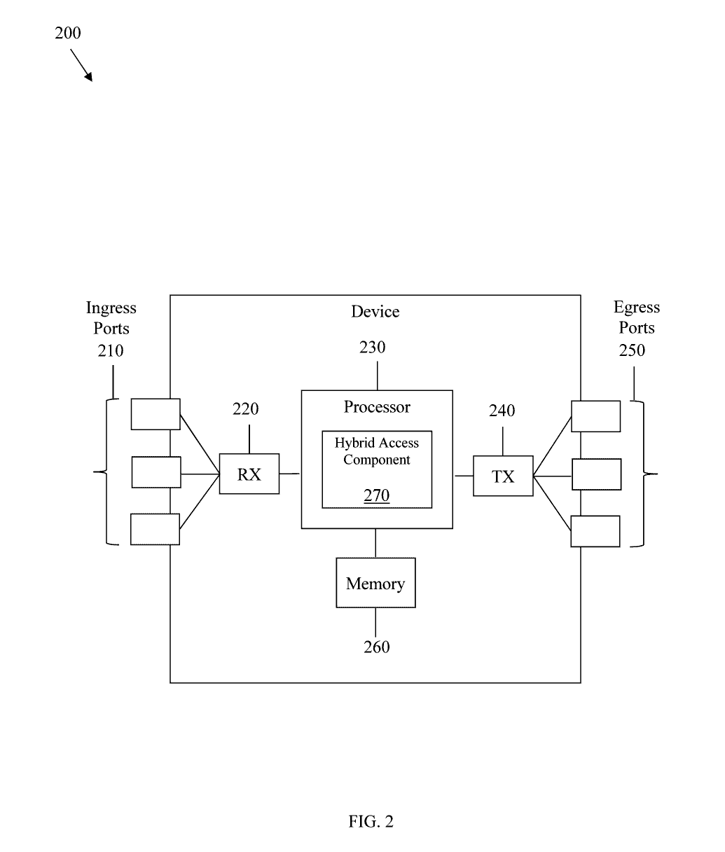

FIG. 2 is a schematic diagram of a device 200 according to an embodiment of the disclosure. The device 200 is suitable for implementing the disclosed embodiments. The device 200 comprises ingress ports 210 and RXs 220 for receiving data; a processor, logic unit, or CPU 230 to process the data; TXs 240 and egress ports 250 for transmitting the data; and a memory 260 for storing the data. The device 200 may also comprise opto-electrical (OE) components and electro-optical (EO) components coupled to the ingress ports 210, the receiver units 220, the transmitter units 240, and the egress ports 250 for ingress or egress of optical or electrical signals.

The processor 230 is implemented by any suitable combination of hardware, middleware, firmware, and software. The processor 230 may be implemented as one or more CPU chips, cores (e.g., as a multi-core processor), FGPAs, ASICs, and DSPs. The processor 230 is in communication with the ingress ports 210, receiver units 220, transmitter units 240, egress ports 250, and memory 260. The processor 230 comprises a hybrid access component 270. The hybrid access component 270 implements the disclosed embodiments. The inclusion of the hybrid access component 270 therefore provides a substantial improvement to the functionality of the device 200 and effects a transformation of the device 200 to a different state. Alternatively, the hybrid access component 270 is implemented as instructions stored in the memory 260 and executed by the processor 230.

The memory 260 comprises one or more disks, tape drives, and solid-state drives and may be used as an over-flow data storage device, to store programs when such programs are selected for execution, and to store instructions and data that are read during program execution. The memory 260 may be volatile and non-volatile and may be ROM, RAM, TCAM, or SRAM.

In one example, the device 200 comprises a first node implemented in a hybrid access network. As a result, the device 200 can comprise the HCPE 120 and/or the HAG 170 of FIG. 1. The device 200 comprises a receiver configured to receive instructions to implement flow-based distribution, a processor coupled to the receiver and configured to generate a first control message instructing the flow-based distribution, and a transmitter coupled to the processor and configured to transmit the first control message to a second node in the hybrid access network. In some examples, the device 200 is a hybrid customer premises equipment (HCPE) and the second node is a hybrid access gateway (HAG) or wherein the first node is the HAG and the second node is the HCPE. In some examples, the first control message comprises a field including an identifier (ID) of a flow to implement the flow-based distribution. In some examples, the device 200 further comprises a first interface configured to couple to a first link of a first protocol, standard, or technology, and a second interface configured to couple to a second link of a second protocol, standard, or technology. In some examples, the first link is a wire link and the second link is a wireless link. In some examples, the first link is a digital subscriber line (DSL) link and the second link is a Long-Term Evolution (LTE) link. In some examples, the first node is configured to transfer packets via the first link and transfer flows via the second link or transfer packets via the second link and transfer flows via the first link. In some examples, the first node is configured to transfer packets via the first link and transfer flows via a second link GRE tunnel in the second link or transfer packets via the second link and transfer flows via a first link GRE tunnel in the first link. In some examples, the first node is configured to switch flows between the first link and the second link. In some examples, the processor is further configured to generate a second control message instructing switching a flow from the first link to the second link, and wherein the transmitter is further configured to transmit the second control message to the second node. In some examples, the first control message and the second control message are Generic Routing Encapsulation (GRE) notify messages.

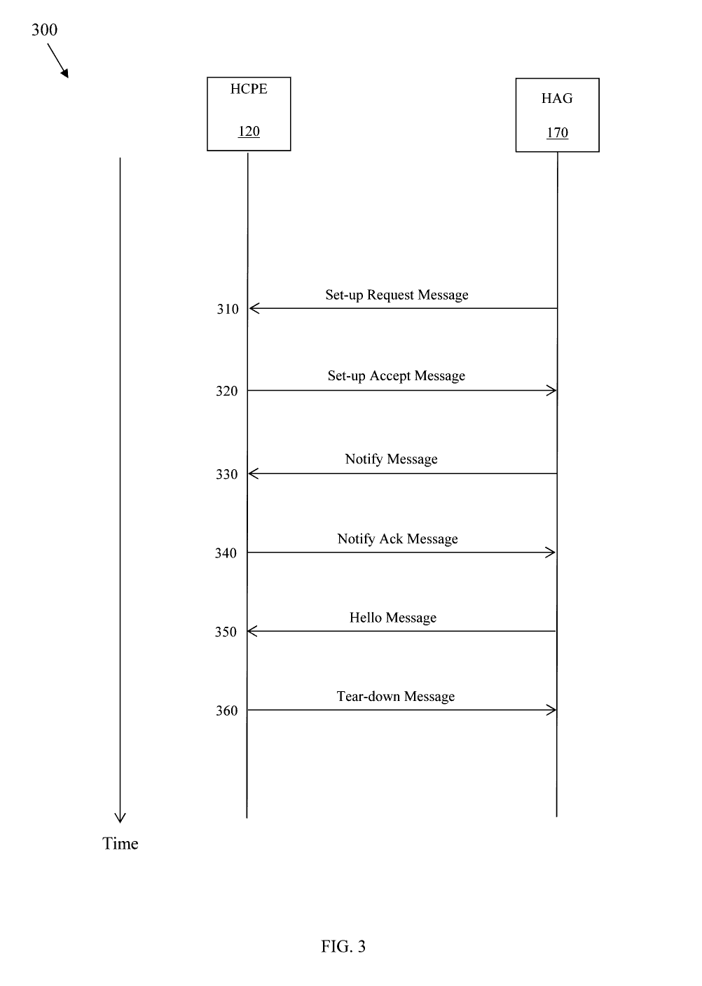

FIG. 3 is a message sequence diagram 300 illustrating establishment of a tunnel using flow-based distribution according to an embodiment of the disclosure. The HCPE 120 and the HAG 170 implement the establishment of the tunnel using GRE control plane messages. Though the diagram 300 shows the messages going in specific directions, the messages may go in either direction.

At step 310, the HAG 170 transmits a set-up request message to the HCPE 120. The set-up request message requests establishment of the DSL tunnel 195. At step 320, the HCPE 120 transmits a set-up accept message to the HAG 170. The set-up accept message accepts establishment of the DSL tunnel 195. Alternatively, the HCPE 120 transmits a set-up deny message to the HAG 170. The set-up deny message denies establishment of the DSL tunnel 195.

At step 330, the HAG 170 transmits a notify message to the HCPE 120. The notify message translates a distribution policy from the operator 190 into a profile that implements the distribution policy. When the distribution policy indicates a flow-based distribution, the profile indicates a switch to the LTE tunnel 197, a 5-tuple that identifies a flow, and other information to implement the flow-based distribution. The HAG 170 desires a switch from the DSL tunnel 195 to the LTE tunnel 197 because the DSL link 130 and the DSL network 150 are congested. The 5-tuple comprises values such as a source IP address, a destination IP address, a source port, a destination port, and a protocol type. G. Tsirtsis, et al., “Traffic Selectors for Flow Bindings,” IETF RFC 6088, January 2011, which is incorporated by reference, defines such values for both IPv4 and IPv6. At step 340, the HCPE 120 transmits a notify ack message to the HAG 170. The notify ack message acknowledges receipt and implementation of the notify message, thus completing a notify message handshake.

The notify message is described further below. The notify message and the notify ack message implement flow-based distribution because they instruct the HCPE 120 and the HAG 170 to use either the DSL link 130 and the DSL network 150 or the LTE link 140 and the LTE network 160 for each flow. The notify message and the notify ack message implement flow mobility because they allow the HCPE 120 and the HAG 170 to switch flows between the DSL tunnel 195 and the LTE tunnel 197 and their respective components. The HCPE 120 and the HAG 170 may switch flows based on network congestion, other network conditions, or other suitable criteria. For example, if the HCPE 120 and the HAG 170 are directing a flow through the DSL link 130 and the DSL network 150, and if the DSL link 130 and the DSL network 150 are congested, then the HCPE 120 and the HAG 170 exchange a notify message and a notify ack message to direct the flow through the LTE link 140 and the LTE network 160. If the HCPE 120 and the HAG 170 are directing a flow through the LTE link 140 and the LTE network 160, and if the LTE link 140 and the LTE network 160 are congested, then the HCPE 120 and the HAG 170 exchange a notify message and a notify ack message to direct the flow through the DSL link 130 and the DSL network 150.

At step 350, the HAG 170 transmits a hello message to the HCPE 120. The hello message indicates whether the HAG 170 has detected a failure of the LTE tunnel 197 and indicates whether the HAG 170 desires to keep the LTE tunnel 197 alive. Finally, at step 360, the HCPE 120 transmits a tear-down message to the HAG 170. The tear-down message instructs the HAG 170 to terminate the LTE tunnel 197.

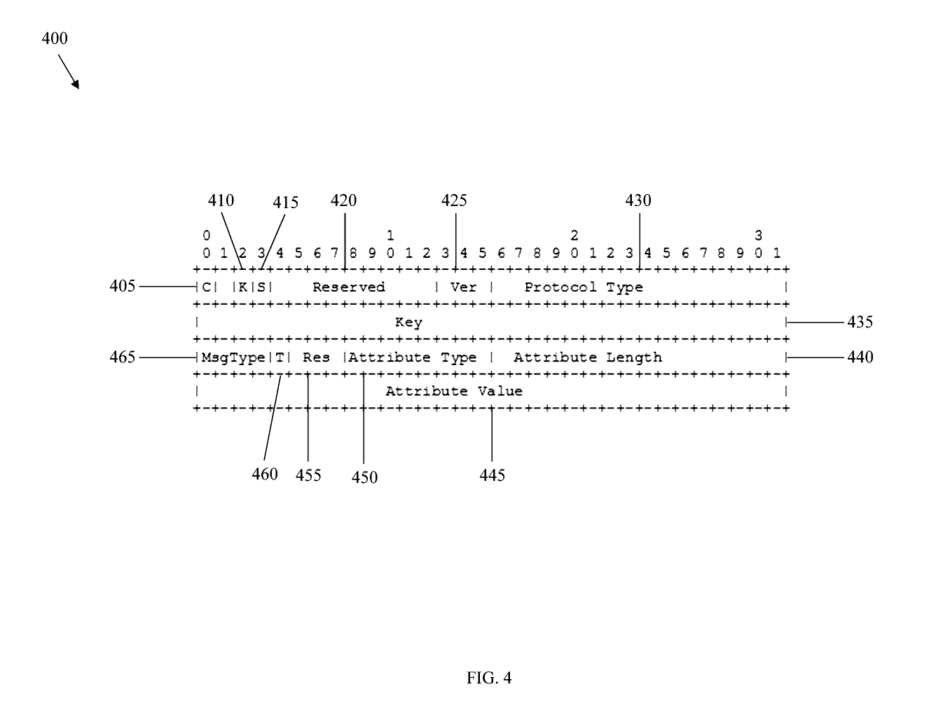

FIG. 4 is a schematic diagram of a header 400 for a control message. The control message is described in “Supporting User Flow Mobility in GRE Notifications for Hybrid Access,” IETF Networking Working Group, Jun. 17, 2015, which is incorporated by reference. The header 400 comprises a (C) field 405, a (K) field 410, an (S) field 415, a reserved field 420, a version (Ver) field 425, a protocol type field 430, a key field 435, an attribute length field 440, an attribute value field 445, an attribute type field 450, a reserved (Res) field 455, a tunnel type (T) field 460, and a message type (MsgType) field 465. The numbers 0-3 above the header 400 indicate byte placement of the fields, the numbers 0-9 indicate bit placement of the fields, and the fields follow sequentially down. Thus, for instance, the version field 425 is located in bits 3-5 of byte 1. The C field 405, the K field 410, the S field 415, the reserved field 420, the version field 425, and the protocol type field 430 make up the first 4 bytes of the header 400; the key field 435 makes up the second 4 bytes of the header 400; the message type field 465, the T field 460, the reserved field 455, the attribute type field 450, and the attribute length field 440 make up the third 4 bytes of the header 400; and the attribute value field 445 makes up the fourth 4 bytes of the header 400.

The C field 405 indicates whether a checksum is present. The K field 410 indicates whether a key is present. The S field 415 indicates whether a sequence number is present. The protocol type field 430 identifies the control protocol for the network 100. For instance, the protocol type field 430 identifies the GRE protocol using the value 0x0101.

The key field 435 comprises a key value that identifies a flow session. The HAG 170 generates a key value for each session and writes each key value to a session table. When the HAG 170 receives a message, it verifies the key value. If the key value is not in the session table, then the HAG 170 discards the message. If the key value is in the session table, then the HAG 170 further processes the message.

The attribute length field 440 identifies a length in bits or bytes of the attribute value field 445. The attribute value field 445 is described further below. The attribute type field 450 identifies a type of an attribute in the attribute value field 445. Select attributes and their corresponding types are shown in Table 1.

TABLE 1
Attributes and Corresponding Types
for the Attribute Type Field 450.

| Attribute | Type |
|---|---|
| CIN | 3 |
| Session ID | 4 |
| Timestamp | 5 |
| Bypass traffic rate | 6 |
| Filter list package | 8 |
| RTT difference threshold | 9 |
| Bypass bandwidth check interval | 10 |
| Switching to DSL tunnel | 11 |
| Overflowing to LTE tunnel | 12 |
| Hello interval | 14 |
| Hello retry times | 15 |
| Idle timeout | 16 |
| Error code | 17 |
| DSL link failure | 18 |
| LTE link failure | 19 |
| IPv6 prefix assigned to terminal host | 21 |
| Subscribed DSL upstream BW | 22 |
| Subscribed DSL downstream BW | 23 |
| Delay difference threshold violation | 24 |
| Delay difference threshold compliance | 25 |
| Filter list ack | 30 |
| End AVP | 255 |
| Reserved | |

The attribute value field 445 identifies a value of an attribute. Values of attributes are as follows. The CIN attribute uniquely identifies the HCPE 120. The HCPE 120 transmits the CIN attribute to the HAG 170 in a set-up request message or a set-up accept message. The HCPE 120 does so for authentication, which is similar to the UE authentication described in “ET TS 123 401” V11.3.0, ETSI, November 2012, which is incorporated by reference. The CIN attribute is about 4 bytes.

The session ID attribute is unique to the HAG 170 and identifies the HCPE 120. The HAG 170 generates the session ID attribute and transmits the session ID attribute in a set-up accept message via the LTE link 140 and the LTE network 160. The HCPE 120 then encapsulates the session ID attribute in a set-up request message and transmits the set-up request message to the HAG 170 via the DSL link 130 and the DSL network 150. With those steps completed, the HCPE 120 and the HAG 170 may bind the DSL tunnel 195 and the LTE tunnel 197 together, meaning that the HCPE 120 and the HAG 170 may properly sequence packets received from both the DSL tunnel 195 and the LTE tunnel 197. If the LTE tunnel 197 fails, but the HCPE 120 or the HAG 170 subsequently attempts to re-establish the LTE tunnel 197, then the set-up request message comprises the session ID. The session ID attribute is about 4 bytes.

The timestamp attribute identifies a local time in seconds and milliseconds of transmission of the header 300. The HCPE 120 and the HAG 170 use the timestamp attribute for RTT calculations. The timestamp attribute is about 8 bytes, where about the first 4 bytes identify the time in seconds and about the second 4 bytes identify the time in milliseconds.

The bypass traffic rate attribute identifies the bypass traffic rate at the HCPE 120 for different kinds of bypass traffic such as IPTV bypass traffic, DNS bypass traffic, or other bypass traffic. The HCPE 120 periodically checks the bypass traffic rate. If the bypass traffic rate has changed by a pre-determined amount or has changed by a pre-determined percentage of the bandwidth of the DSL tunnel 195, then the HCPE 120 transmits the bypass traffic rate attribute to the HAG 170. The HAG 170 calculates the available bandwidth of the DSL tunnel 195 using the bypass traffic rate attribute. The bypass traffic rate attribute is about 4 bytes.

The filter list package attribute is a list of services to be routed through either the DSL tunnel 195 or the LTE tunnel 197, but not both. The HAG 170 creates the filter list package for the HCPE 120. The filter list package is described further below. The filter list package attribute is about 969 bytes.

The RTT difference threshold attribute is associated with a difference in RTT between the DSL tunnel 195 and the LTE tunnel 197. The HAG 170 assigns the RTT difference threshold to the HCPE 120. If the RTT difference between the DSL tunnel 195 and the LTE tunnel 197 exceeds the RTT difference threshold, then the HCPE 120 may transmit to the HAG 170 a notify message comprising the switching to DSL tunnel attribute so that the HAG 170 uses only the DSL tunnel 195. The RTT difference threshold is in milliseconds from about 0 ms to about 1,200 ms and is configurable in about 1 ms increments. The RTT difference threshold is about 4 bytes.

The bypass bandwidth check interval attributes how often the HCPE 120 should check the bypass bandwidth of the DSL tunnel 195. The bypass bandwidth check interval is in seconds from about 10 s to about 300 s and is configurable in about 1 s increments. The HAG 170 assigns the bypass bandwidth check interval to the HCPE 120. The bypass bandwidth check interval is about 4 bytes.

The switching to DSL tunnel attribute instructs the HAG 170 to use only the DSL tunnel 195. The HCPE 120 transmits to the HAG 170 the notify message, including the switching to DSL tunnel attribute, when the RTT difference between the DSL tunnel 195 and the LTE tunnel 197 exceeds the RTT difference threshold. The switching to DSL tunnel attribute is about 0 bytes because there is no value for it.

The overflowing to LTE tunnel attribute is included in a notify message and instructs the HAG 170 to use the LTE tunnel 197 for overflow traffic. The HCPE 120 transmits to the HAG 170 the notify message, including the overflowing to LTE tunnel attribute, when the RTT difference between the DSL tunnel 195 and the LTE tunnel 197 does not exceed the RTT difference threshold. The overflowing to LTE tunnel attribute is about 0 bytes because there is no value for it.

The hello interval attribute identifies an interval during which the HCPE 120 and the HAG 170 are to negotiate a hello message. The HAG 170 assigns the hello interval to the HCPE 120. The hello interval is in seconds from about 1 s to about 100 s and is configurable in about 1 s increments. The hello interval attribute is about 4 bytes.

The hello retry times attribute identifies the maximum number of times that the HCPE 120 and the HAG 170 may exchange hello messages. The HAG 170 assigns the hello retry times to the HCPE 120. The hello retry times is between about 3 and about 10 and is configurable in increments of about 1. The hello retry times attribute is about 4 bytes.

The idle timeout attribute identifies the maximum period during which either the DSL tunnel 195 or the LTE tunnel 197 may be idle once established. The HAG 170 assigns the idle timeout to the HCPE 120. If either the DSL tunnel 195 or the LTE tunnel 197 is idle beyond the period of the idle timeout, then the HCPE 120 and the HAG 170 terminate both the DSL tunnel 195 and the LTE tunnel 197. The idle timeout is in seconds from about 0 s to about 172,800 s and is configurable in about 60 s increments. The idle timeout attribute is about 4 bytes.

The error code attribute identifies an error in the network 100. Upon receipt of the error code, the HCPE 120 or the HAG 170 responds accordingly. The error code attribute is about 4 bytes.

The DSL link failure attribute identifies a failure of the DSL link 130 coupled to the HCPE 120. The HCPE 120 transmits to the HAG 170 the DSL link failure attribute in any suitable message. The DSL link attribute is about 0 bytes because there is no value for it.

The LTE link failure attribute identifies a failure of the LTE link 140 coupled to the HCPE 120. The HCPE 120 transmits to the HAG 170 the LTE link failure attribute in any suitable message. The LTE link attribute is about 0 bytes because there is no value for it.

The IPv6 prefix assigned to terminal host attribute identifies an IPv6 prefix assigned to the terminal host of the HCPE 120. If the HCPE 120 changes the IPv6 prefix assigned to its terminal host, then the HCPE 120 transmits to the HAG 170 a notify message including the IPv6 prefix assigned to terminal host attribute. The IPv6 prefix assigned to terminal host attribute is about 17 bytes, where about the first 16 bytes identify the IPv6 prefix assigned to the terminal host and about the last 1 byte identifies a network mask of the network 100.

The subscribed DSL upstream BW attribute identifies the available upstream BW for the DSL tunnel 195. The HAG 170 determines the subscribed DSL upstream BW during an authentication process and transmits the subscribed DSL upstream BW attribute to the HCPE 120. The HCPE 120 and the HAG 170 use the subscribed DSL upstream BW to determine a token bucket for the DSL tunnel 195. A token bucket is an algorithm that is used to check that data transmissions conform to defined limits on BW and burstiness. The subscribed DSL upstream BW is in kilobits per second. The subscribed DSL upstream BW attribute is about 4 bytes.

The subscribed DSL downstream BW attribute identifies the available downstream BW for the DSL tunnel 195. The HAG 170 determines the subscribed DSL downstream BW during an authentication process and transmits the subscribed DSL downstream BW attribute to the HCPE 120. The HCPE 120 and the HAG 170 use the subscribed DSL downstream BW to determine a token bucket for the DSL tunnel 195. The subscribed DSL downstream BW is in kilobits per second. The subscribed DSL downstream BW attribute is about 4 bytes.

The delay difference threshold violation attribute identifies the maximum number of times that the RTT difference between the DSL tunnel 195 and the LTE tunnel 197 may exceed the RTT difference threshold. If the network 100 exceeds the delay difference threshold violation, then the network uses the DSL tunnel 195 and terminates the LTE tunnel 197. The operator 190 may configure the delay difference threshold violation, and the HAG 170 assigns the delay difference threshold violation to the HCPE 120. The delay difference threshold violation attribute is about 4 bytes.

The delay difference threshold compliance attribute identifies the minimum number of times that the RTT difference between the DSL tunnel 195 and the LTE tunnel 197 may not exceed the RTT difference threshold. If the network 100 does not exceed the delay difference threshold compliance, then the network uses both the DSL tunnel 195 and the LTE tunnel 197. The operator 190 may configure the delay difference threshold compliance, and the HAG 170 assigns the delay difference threshold violation to the HCPE 120. The delay difference threshold violation attribute is about 4 bytes.

The filter list ack attribute is an acknowledgment of the filter list package attribute. The filter list ack attribute comprises a commit count field and an error code field. The commit count field differentiates filter list packages in case there is a change in them. The error code field has a value of 0 for an acknowledgment, a value of 1 for a nack that indicates a new subscriber, or a value of 2 for a negative acknowledgment that indicates an existing subscriber. The filter list ack attribute is described further below. The filter list ack attribute is about 5 bytes, where the first 4 bytes are the commit count field and the last 1 byte is the error code field.

The end AVP attribute identifies that it is the last attribute in the control message. The end AVP attribute is about 0 bytes because there is no value for it. Additional attributes are reserved for future assignment. As shown, the attributes vary in size, so the attribute value field 445 may likewise vary in size. As an example, for the filter list package attribute, the attribute type field 450 is set to a value of 8, the attribute length field 440 is set to a value of 969, and the attribute value field 445 comprises the filter list package described below.

The Res field 455 is reserved for future assignment. The T field 460 identifies what tunnel type the control message is used for. For instance, if the value of the T field 460 is 1, then the control message is used for the DSL tunnel 195. If the value of the T field 460 is another value, then the control message is used for the LTE tunnel 197.

Finally, the MsgType field 465 identifies the type of control message. The messages and their corresponding types are shown in Table 2.

TABLE 2
Messages and Corresponding Types

| Message | Type |
|---|---|
| GRE set-up request | 1 |
| GRE set-up accept | 2 |
| GRE set-up deny | 3 |
| GRE hello | 4 |
| GRE tear-down | 5 |
| GRE notify | 6 |
| Reserved | 0, 7-15 |

In this case, the MsgType field 465 may have a value of 6 to indicate that the control message is a notify message.

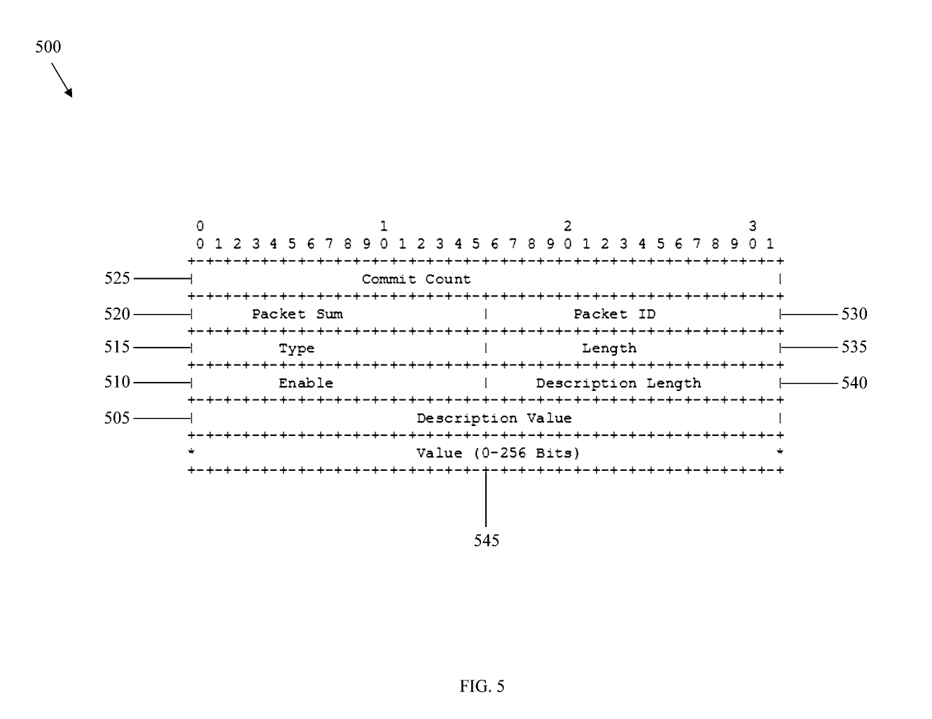

FIG. 5 is a schematic diagram of a filter list package attribute 500 according to an embodiment of the disclosure. The filter list package attribute 500 may make up the attribute value field 445 when the attribute type field 450 has a value of 8. The filter list package attribute 500 comprises a description value field 505, an enable field 510, a type field 515, a packet sum field 520, a commit count field 525, a packet ID field 530, a length field 535, a description length field 540, and a value field 545. The numbers 0-3 above the filter list package attribute 500 indicate byte placement of the fields, the numbers 0-9 indicate bit placement of the fields, and the fields follow sequentially down. Thus, for instance, the packet ID field 530 is located in bits 6-9 of byte 1, bits 0-9 of byte 2, and bits 0-1 of byte 3. The commit count field 525 makes up the first 4 bytes of the filter list package attribute 500, the packet sum field 520 and the packet ID field 530 make up the second 4 bytes of the filter list package attribute 500, the type field 515 and the length field 535 make up the third 4 bytes of the filter list package attribute 500, the enable field 510 and the description length field 540 make up the fourth 4 bytes of the filter list package attribute 500, the description value field 505 makes up the fifth 4 bytes of the filter list package attribute 500, and the value field 545 makes up the sixth 4 bytes of the filter list package attribute 500.

The description value field 505 of FIG. 5 identifies the flow ID. The flow ID initializes at 1 and is an ASCII format. The HCPE 120 and the HAG 170 add the flow ID to the flow table after transmitting or receiving a first notify message. Subsequent notify messages may instruct a modified 5-tuple for the flow table by identifying the same flow ID in the description value field 505, but a new 5-tuple in the value field 545.

The fully qualified domain name filter list is a complete domain name for a component in the network 100 and comprises a hostname and a domain name. The DSCP filter list identifies different levels of service to be assigned to traffic. The destination port filter list identifies a destination port of a node that a flow is destined for. The destination IP address filter list identifies an IP address of a node that the flow is destined for. The destination IP address and port filter list identifies the latter two filter lists. The source port filter list identifies a source port of a node that the flow is initially transmitted from. The source IP address identifies an IP address of a node that the flow is initially transmitted from. The source IP address and port filter list identifies the latter two filter lists. The source MAC address filter list identifies a MAC address of a node that the flow is initially transmitted from. The protocol type filter list identifies a protocol that the flow is using. The source IP address range filter list identifies a range of IP addresses of nodes that the flow is initially transmitted from. The destination IP address range filter list identifies a range of IP addresses of nodes that the flow is destined for. The source IP address range and port filter list identifies a combination of the source IP address range filter list and the source port filter list. The destination IP address range and port filter list identifies a combination of the destination IP address range filter list and the destination port filter list. Finally, additional filter lists are reserved for future assignment.

The enable field 510 identifies whether the filter list is enabled. A value of 1 indicates that the filter list is enabled, and a value of 0 indicates that the filter list is not enabled. Other values are reserved for future assignment.

The type field 515 identifies the filter list type or types. The filter list types and their corresponding type values are shown in Table 3.

TABLE 3
Filter List Types and Corresponding Type Values

| Filter List | Type |
|---|---|
| Fully qualified domain name | 1 |
| DSCP | 2 |
| Destination port | 3 |
| Destination IP address | 4 |
| Destination IP address and port | 5 |
| Source port | 6 |
| Source IP address | 7 |
| Source IP address and port | 8 |
| Source MAC address | 9 |
| Protocol type | 10 |
| Source IP address range | 11 |
| Destination IP address range | 12 |
| Source IP address range and port | 13 |
| Destination IP address range and port | 14 |
| Reserved | |

As mentioned above, the 5-tuple comprising the source IP address, the destination IP address, the source port, the destination port, and the protocol type identify the flow. Thus, the 5-tuple may comprise any suitable combination of the filter list types that sufficiently identify the 5-tuple and thus the flow.

The packet sum field 520 identifies a total number of sub-packets for a filter list package. Specifically, if the filter list package size is greater than the MTU size allowed in the network 100, then the HCPE 120 and the HAG 170 divide the filter list package into sub-packets. If the filter list package size is less than or equal to the MTU size, then the sum field 520 has a value of 1.

The commit count field 525 identifies the filter list package version. Thus, if the HAG 170 transmits an updated filter list package to the HCPE 120, then the HAG 170 updates the commit count with a new filter list package version and transmits the updated commit count to the HCPE 120. Upon receiving the updated commit count, the HCPE 120 refreshes its values for the filter list package with the contents of the updated filter list package.

The packet ID field 530 identifies a sequence number of the sub-packets from the filter list package. When the HCPE 120 and the HAG 170 divide the filter list package into sub-packets, they sequentially number those sub-packets with the sequence number in the packet ID field 530. The HCPE 120 and the HAG 170 then communicate the sequence numbers in the packet ID field 530 along with their corresponding sub-packets in the value field 545.

The length field 535 identifies a length in bits or bytes of the type of filter list described in the description value field 505. Thus, the length field 535 identifies the length of the value field 545. The description length field 540 identifies a length in bits or bytes of the description value field 505. Finally, the value field 545 identifies the value of the filter list type or the values of the filter list types.

The HCPE 120 stores, the HAG 170 stores, or both the HCPE 120 and the HAG 170 store the flow table. The flow table comprises the 5-tuple from the value field 545 in the filter list package attribute 500, the tunnel type from the T field 460 in the header 400, and the flow ID from the description value field 505 in the filter list package attribute 500.

In the control plane, the HAG 170 may assign to the HCPE 120 a distribution policy required by the operator 190, a flow table, and flow mobility. Similarly, the HCPE 120 may assign to the HAG 170 the distribution policy required by the operator 190, the flow table, and the flow mobility. As an example, to set up and assign a flow table, the HAG 170 transmits to the HCPE 120 a notify message with a filter list package. Thus, the HAG 170 transmits the header 400 with the MsgType field 465 set to a value of 6 to identify a notify message and the attribute type field 450 set to a value of 8 to identify a filter list package. The 5-tuple comprising the source IP address, the destination IP address, the source port, the destination port, and the protocol type identify a flow corresponding to the flow table. Thus, the HAG 170 transmits the filter list package attribute 500 with the type field 515 set to a value of 7 for the source IP address, 4 for the destination IP address, 6 for the source port, 3 for the destination port, and 10 for the protocol type, or the HAG 170 transmits the filter list package attribute 500 with other suitable filter list types that satisfy the 5-tuple. In addition, the HAG 170 transmits the filter list package attribute 500 with the description value field 505 set to a value of the flow ID.

In response, the HCPE 120 transmits to the HAG 170 a notify acknowledgment message. Thus, the HCPE 120 transmits the header 400 with the MsgType field 465 set to a value of 6 to identify a notify message and the attribute type field 450 set to a value of 30 to identify the filter list ack. The error code field has a value of 0 for an acknowledgment, a value of 1 for a negative acknowledgment that indicates a new subscriber, or a value of 2 for a negative acknowledgment that indicates an existing subscriber.

If the HCPE 120 receives the notify message from the HAG 170 over the DSL tunnel 195, then the HCPE 120 transmits the notify acknowledgment message to the HAG 170 over the DSL tunnel 195. Likewise, if the HCPE 120 receives the notify message from the HAG 170 over the LTE tunnel 197, then the HCPE 120 transmits the notify acknowledgment message to the HAG 170 over the LTE tunnel 197. If the HAG 170 transmits the notify message using the LTE tunnel 197 and the LTE link tunnel is not congested, then the HCPE 120 transmits the notify acknowledgment message using the LTE tunnel 197 and sets the value of the error code field to 0 for an acknowledgment. If the HAG 170 transmits a first notify message using the LTE tunnel 197 and the LTE tunnel 197 is congested, then the HCPE 120 transmits a first notify acknowledgment message using the LTE tunnel 197 and sets the value of the error code field to a non-zero value. The HAG 170 then transmits a second notify message using the DSL tunnel 195, and the HCPE 120 transmits a second notify acknowledgment message using the DSL tunnel 195 and sets the value of the error code field to 0 to indicate that the HCPE 120 has moved the flow from the LTE tunnel 197 to the DSL tunnel 195.

In the data plane, the HCPE 120 reads the flow table, filters data packets from the UEs 110 to determine data packets corresponding to the flow associated with the flow table, encapsulates the filtered data packets, and transmits the encapsulated data packets to the HAG 170 using either the DSL tunnel 195 or the LTE tunnel 197. The HCPE determines the appropriate tunnel from the flow table.

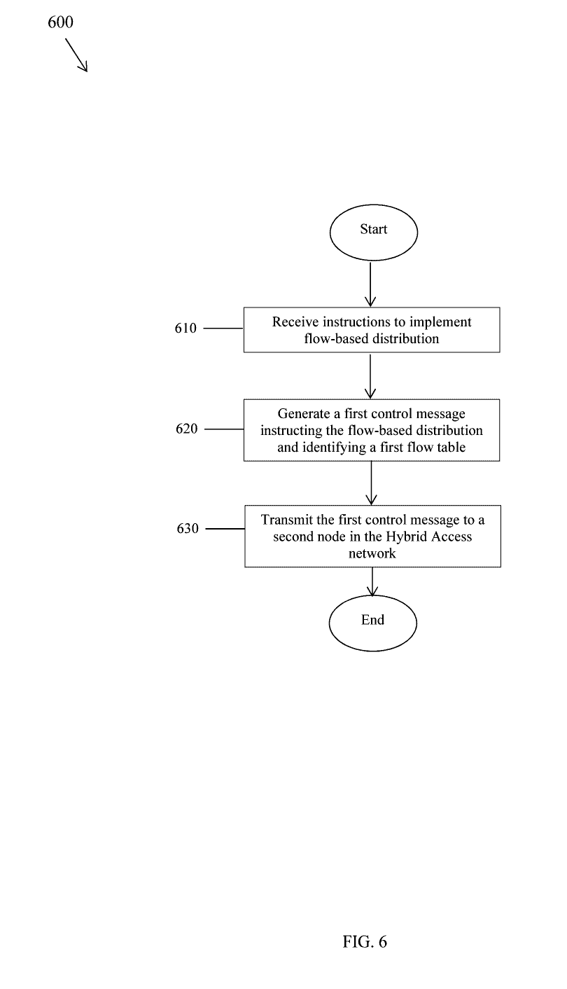

FIG. 6 is a flowchart illustrating a method 600 of instructing flow-based distribution according to an embodiment of the disclosure. The HCPE 120 or the HAG 170 implements the method 600. At step 610, instructions to implement flow-based distribution are received. For instance, the HAG 170 receives from the operator 190 instructions to implement flow-based distribution. At step 620, a first control message instructing the flow-based distribution and identifying a first flow table is generated. For instance, the HAG 170 generates a notify message comprising the header 400 and the attribute 500. Finally, at step 630, the first control message is transmitted to a second node in a hybrid access network. For instance, the HAG 170 transmits the notify message to the HCPE 120.

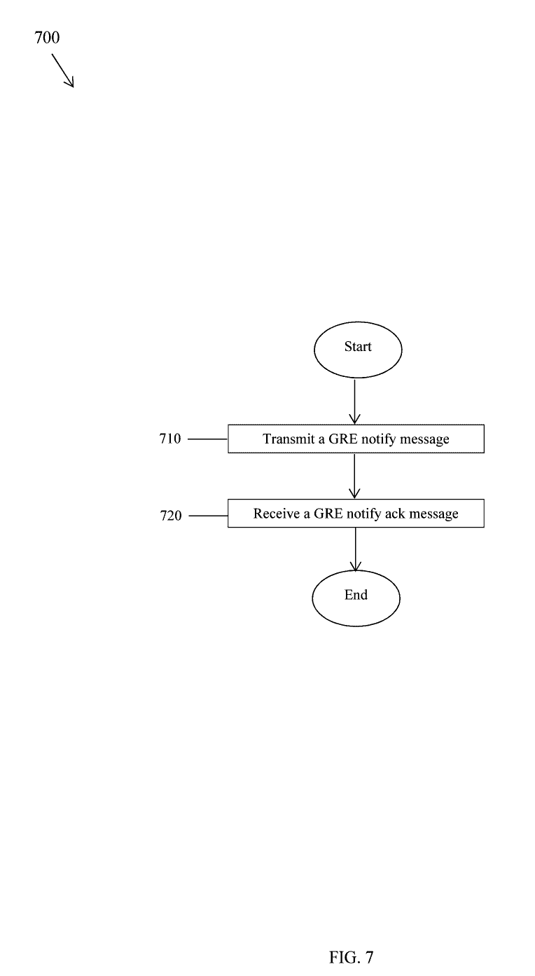

FIG. 7 is a flowchart illustrating a method 700 of a GRE notify message handshake according to an embodiment of the disclosure. At step 710, a GRE notify message is transmitted. For instance, the HAG 170 transmits the GRE notify message to the HCPE 120 via the DSL tunnel 195. The notify message comprises the header 400, which has the MsgType field 465 set to 6 to indicate a GRE notify message, the attribute type field 450 set to 8 to indicate the filter list package attribute 500, and the T field 460 set to 2 to indicate the DSL tunnel 195. The filter list package attribute 500 has the description value field 505 set to a number to identify a flow ID and the 5-tuple in the value field 545 to identify a flow associated with the flow ID. The HCPE 120 stores a flow table comprising the 5-tuple from the value field 545 in the filter list package attribute 500, the tunnel from the T field 460 in the header 400, and the flow ID from the description value field 505 in the filter list package attribute 500.

Finally, at step 720, a GRE notify ack message is received. For instance, the HAG 170 receives the GRE notify ack message from the HCPE 120 via the DSL tunnel 195. The notify ack message comprises the header 400, which has the MsgType field 465 set to 6 to indicate a GRE notify message, the attribute type field 450 set to 30 to indicate the filter list ack attribute. The filter ack attribute has an error code field set to a value of 0 to indicate an acknowledgment.

Though the method 700 comprises a GRE notify message from the HAG 170 to the HCPE 120, the GRE notify message may be from the HCPE 120 to the HAG 170. Similarly, the notify ack message may be from the HAG 170 to the HCPE 120. In addition, the T field 460 may indicate the LTE tunnel 197 instead of the DSL tunnel 195. Furthermore, the HAG 170 may store the flow table. Additionally, the HCPE 120 and the HAG 170 may implement flow mobility using the GRE notify message to instruct switching the flow from the DSL tunnel 195 to the LTE tunnel 197 and using the GRE notify ack message to acknowledge the GRE notify message.

In an example embodiment, a first node includes a receiving module configured to receive instructions to implement flow-based distribution, a processing module configured to generate a first control message instructing the flow-based distribution, and a transmitting module configured to transmit the first control message to a second node in the hybrid access network. In some embodiments, the first node may include other or additional modules for performing any one of or combination of steps described in the embodiments.

In an example embodiment, a first node includes a receiving module configured to receive packets, a processing module configured to encapsulate the packets to create encapsulated packets and generate a first control message instructing flow-based distribution and comprising a first flow table, wherein the first flow table identifies a flow and comprises instructions for processing packets belonging to the flow, and a transmitting module configured to transmit the first control message to a second node in the hybrid access network and transmit the encapsulated packets to the second node for processing based on the first control message. In some embodiments, the first node may include other or additional modules for performing any one of or combination of steps described in the embodiments.

In an example embodiment, a first node includes a processing module configured to generate a Generic Routing Encapsulation (GRE) notify message comprising a first header and a filter list package attribute, wherein the first header comprises a first message type field identifying the GRE notify message, a first attribute type field identifying the filter list package attribute, and a tunnel type field identifying a tunnel, and wherein the filter list package attribute comprises a description value field identifying a flow identifier (ID) and a 5-tuple identifying a flow associated with the flow ID, and a transmitter module coupled to the processor and configured to transmit, via a tunnel, the GRE notify message to a second node. In some embodiments, the first node may include other or additional modules for performing any one of or combination of steps described in the embodiments.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A first node implemented in a hybrid access network, the first node comprising:
a receiver configured to receive instructions to implement flow-based distribution;
a processor coupled to the receiver and configured to generate a first control message instructing the flow-based distribution, with the first control message including a flow identifier (ID) that identifies a flow; and
a transmitter coupled to the processor and configured to transmit the first control message to a second node in the hybrid access network.

2. The first node of claim 1, wherein the first node is a hybrid customer premises equipment (HCPE) and the second node is a hybrid access gateway (HAG) or wherein the first node is a hybrid access gateway (HAG) and the second node is a hybrid customer premises equipment (HCPE).

3. The first node of claim 1, wherein the first control message comprises a description value field identifying the flow ID of the flow to implement the flow-based distribution.

4. The first node of claim 1, further comprising:
a first interface configured to couple to a first link of a first protocol, standard, or technology; and
a second interface configured to couple to a second link of a second protocol, standard, or technology.

5. The first node of claim 4, wherein the first link is a wired link and the second link is a wireless link.

6. The first node of claim 5, wherein the first link is a digital subscriber line (DSL) link and the second link is a Long-Term Evolution (LTE) link.

7. The first node of claim 4, wherein the first node is configured to transfer packets via the first link and transfer flows via the second link or transfer packets via the second link and transfer flows via the first link.

8. The first node of claim 4, wherein the first node is configured to transfer packets via the first link and transfer flows via a second link GRE tunnel in the second link or transfer packets via the second link and transfer flows via a first link GRE tunnel in the first link.

9. The first node of claim 4, wherein the first node is configured to switch flows between the first link and the second link.

10. The first node of claim 4, wherein the processor is further configured to generate a second control message instructing switching a flow from the first link to the second link, and wherein the transmitter is further configured to transmit the second control message to the second node.

11. The first node of claim 10, wherein the first control message and the second control message are Generic Routing Encapsulation (GRE) notify messages.

12. A method implemented in a first node of a hybrid access network, the method comprising:
receiving instructions to implement flow-based distribution;
generating a first control message instructing the flow-based distribution and identifying a first flow table, with the first control message including a flow ID that identifies a flow; and
transmitting the first control message to a second node in the hybrid access network.

13. The method of claim 12, further comprising:
coupling to a first tunnel of a first protocol, standard, or technology; and
coupling to a second tunnel of a second protocol, standard, or technology.

14. The method of claim 13, further comprising switching the flow between the first tunnel and the second tunnel based on network congestion or network conditions.

15. The method of claim 13, further comprising:
generating a second control message instructing switching the flow from the first tunnel to the second tunnel and identifying a second flow table; and
transmitting the second control message to the second node.

16. A first node implemented in a hybrid access network, the first node comprising:
a receiver configured to receive packets;
a processor coupled to the receiver and configured to:
encapsulate the packets to create encapsulated packets, and
generate a first control message instructing flow-based distribution and comprising a first flow table, wherein the first flow table identifies a flow and comprises instructions for processing packets belonging to the flow; and
a transmitter coupled to the processor and configured to:
transmit the first control message to a second node in the hybrid access network, and
transmit the encapsulated packets to the second node for processing based on the first control message.

17. The first node of claim 16, wherein the first node is a hybrid customer premises equipment (HCPE), wherein the receiver is further configured to further receive the packets from one or more user equipments (UEs), wherein the packets are data packets, and wherein the processor is further configured to further encapsulate the packets using Generic Routing Encapsulation (GRE).

18. The first node of claim 16, wherein the first node is a hybrid access gateway (HAG), wherein the receiver is further configured to further receive the packets from a service, wherein the packets are Internet Protocol (IP) packets, and wherein the processor is further configured to further encapsulate the packets using Generic Routing Encapsulation (GRE).

19. The first node of claim 16, wherein the first control message comprises:
a message type (MsgType) field indicating a Generic Routing Encapsulation (GRE) notify message; and
an attribute type field indicating a filter list package,
wherein the filter list package comprises the first flow table and a 5-tuple identifying the flow, and
wherein the filter list package identifies a single node associated with the flow or identifies a plurality of nodes associated with the flow.

20. The first node of claim 19, wherein the first control message is a Generic Routing Encapsulation (GRE) notify message, wherein the receiver is further configured to receive, in response to the first control message, a second control message that is a GRE notify acknowledgment (ack) message, and wherein the first control message and the second control message complete a control message handshake.

21. The first node of claim 16, wherein the processor is further configured to generate a second control message instructing switching the flow from a digital subscriber line (DSL) link to a Long-Term Evolution (LTE) link using a second flow table, wherein the second control message comprises a message type (MsgType) field indicating a Generic Routing Encapsulation (GRE) notify message and an attribute type field indicating a filter list package, wherein the filter list package comprises the second flow table and a 5-tuple identifying the flow, and wherein the transmitter is further configured to transmit the second control message to the second node.

22. The first node of claim 16, wherein the first node is configured to switch the flow between a first link and a second link.

23. A first node comprising:
a processor configured to generate a Generic Routing Encapsulation (GRE) notify message comprising a first header and a filter list package attribute, wherein the first header comprises a first message type field identifying the GRE notify message, a first attribute type field identifying the filter list package attribute, and a tunnel type field identifying a tunnel, and wherein the filter list package attribute comprises a description value field identifying a flow identifier (ID) and a 5-tuple identifying a flow associated with the flow ID; and
a transmitter coupled to the processor and configured to transmit, via a tunnel, the GRE notify message to a second node.

24. The first node of claim 23, further comprising a receiver coupled to the processor and configured to receive, via the tunnel, a GRE notify acknowledgment (ack) message in response to the GRE notify message, wherein the GRE notify ack message comprises a second header and a filter list ack attribute, wherein the second header comprises a second message type field identifying the GRE notify ack message and a second attribute type field identifying the filter list ack attribute, wherein the filter list ack attribute comprises an error code identifying an acknowledgment, and wherein the processor is further configured to process the GRE notify ack message.
